(19) United States
(12) Patent Application Publication
(10) Pub. No.: US 2008/0319777 A1
(43) Pub. Date: Dec. 25, 2008

(54) Business transaction issue manager

(76) Inventor: Roland Hoff, Walldorf (DE)

Correspondence Address: BRAKE HUGHES BELLERMANN LLP, C/O INTELLEVATE, P.O. BOX 52050, MINNEAPOLIS, MN, 55402, US

(21) Appl. No.: 11/820,701

(22) Filed: Jun. 20, 2007

(51) Int. Cl. G06Q 10/00; G06F 17/30

(52) U.S. Cl. 705/1

(57) ABSTRACT

A plurality of business transactions associated with a user may be determined based on a role of the user, wherein each business transaction includes business data associated with the business transaction. A user-defined issue based on the plurality of business transactions may be received, the user-defined issue including at least one of an issue-type, one or more issue-definitions based on the business data, and one or more priorities associated with the one or more issue-definitions. One or more business transactions of the plurality of business transactions in which the business data of each of the one or more business transactions corresponds to one or more of the issue-definitions may be determined. The one or more business transactions may be provided in association with the user-defined issue and including at least a portion of the business data.

### TECHNICAL FIELD

This description relates to the management of issues that may arise with respect to business transactions.

### BACKGROUND

A company may interact with its customers through one or more representatives assigned to different tasks. For example, the representatives may be assigned to tasks dependent on which department the representative belongs to, including, for example, a sales department, help desk, finance department, and engineering department. Or, for example, the representatives may divide tasks dependent upon which customer is associated with a transaction. Or a combination of the two methods and/or additional methods may be used to assign the representatives responsibility for interactions and/or transactions with customers.

As the company grows and does business, both the client list and the number of transactions and/or interactions occurring with respect to the clients may grow, and may become difficult for the company representative to manage. Being able to quickly filter through and/or sort the transactions based on a priority with regard to potential issues that may arise, may allow the representatives to address those transactions and/or issues that are of the greatest importance first, thereby saving the representative time and effort and potentially saving the company its reputation by addressing the most important issues first and in a timely manner.

### SUMMARY

According to an example embodiment a system is provided, in which a definition engine may be configured to receive one or more user-defined issues based on a role associated with a user, the one or more user-defined issues including an issue-type, one or more issue-definitions and one or more priorities corresponding to the one or more issue-definitions. An account manager may be configured to determine one or more accounts associated with the user, each account including business data associated with at least one of a plurality business transactions. A filter may be configured to determine at least one or more of the plurality of business transactions associated with the one or more user-defined issues based on a comparison of the business data with the one or more issue-definitions. A priority engine may be configured to determine which of the one or more priorities correspond to each of the one or more business transactions, based on the comparison. A view generator may be configured to generate one or more views including at least a grouping of the one or more business transactions in association with at least a portion of the business data and the one or more user-defined issues.

According to anther example embodiment a computer program product may be used for handling a plurality of business transactions, associated with a user, including business data consistent with a user-defined issue defined by the user, the computer program product being tangibly embodied on a computer-readable medium and including executable code that, when executed, is configured to cause a data processing apparatus to provide a business transaction interface. The business transaction interface may include a grouped plurality of fields that are grouped with respect to each of the plurality of business transactions, including: an issue-type field configured to identify the user-defined issue, a business transaction identification field configured to identify each of the plurality of business transactions, an issue-reason field configured to provide results of a comparison of the business data of each of the plurality of business transactions with an issue-definition of the user-defined issue, and a priority field configured to provide a priority associated with each business transaction of the plurality of business transactions based on the issue-reason field wherein the issue-definition corresponds to the priority.

According to another example embodiment a method is provided. A plurality of business transactions associated with the user, wherein each business transaction includes business data associated with the business transaction, may be determined, based on a role of a user. A user-defined issue based on the plurality of business transactions may be received, the user-defined issue including at least one of an issue-type, one or more issue-definitions based on the business data, and one or more priorities associated with the one or more issue-definitions. One or more business transactions of the plurality of business transactions may be determined in which the business data of each of the one or more business transactions corresponds to one or more of the issue-definitions. The one or more business transactions may be provided in association with the user-defined issue and including at least a portion of the business data.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for a business transaction workbench system, according to an example embodiment.

FIG. 2 is a block diagram of an example system for a business transaction workbench system, according to an example embodiment.

FIG. 3 is a flowchart illustrating example operations of the system of FIG. 2.

FIG. 4 is a block diagram of an example summary view, from FIG. 2, according to an example embodiment.

FIG. 5 is a block diagram of an example business transaction view, from FIG. 2, according to an example embodiment.

FIG. 6 is a flowchart illustrating example operations of the system of FIG. 2.

### DETAILED DESCRIPTION

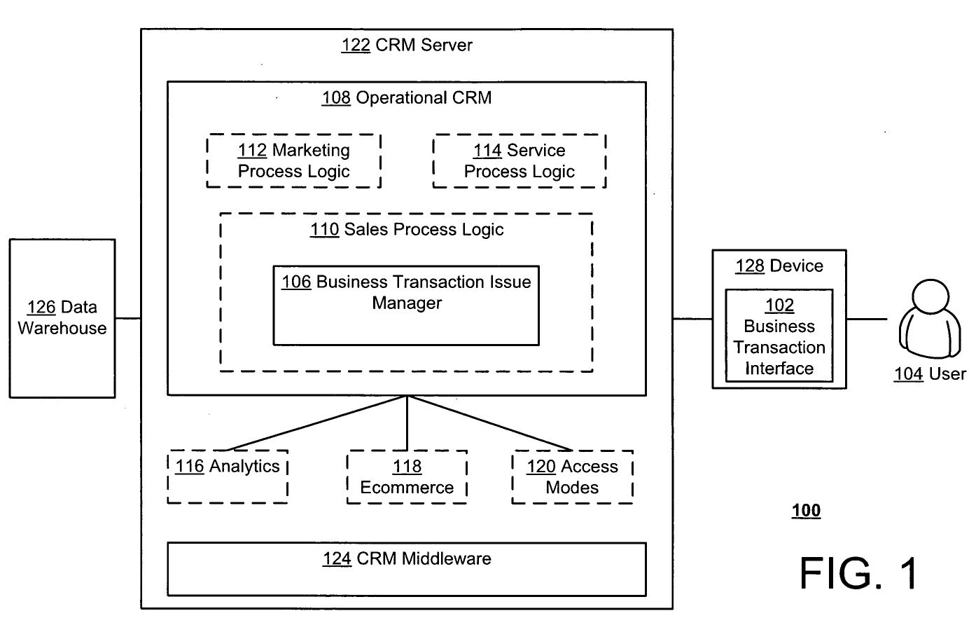

FIG. 1 is a block diagram of an example system 100 for a business transaction workbench system, according to an example embodiment. In the example of FIG. 1, the system 100 determines, from a plurality of business transactions associated with a sales representative, which of the business transactions correspond to one or more issues, as may be defined by the sales representative.

For example, a sales representative may be responsible for multiple customer accounts which may each be associated with a plurality of business transactions, including sales orders, quotations, current contracts and opportunities. This may result in the sales representative being responsible for a large number of business transactions across multiple customer accounts, which may be, or may become, difficult to manage. To better manage the business transactions, the sales representative may, for example, define one or more issues whereby the system 100 may notify the sales representative when a business transaction, and/or business data associated therewith, corresponds to one or more of the issues. Then, for example, upon receiving notification of an issue with one or more of the business transactions, the sales representative may be able to quickly determine which issues to address first, based on a relative priority associated with the detected issues.

As just referenced, the sales representative may use the data to perform a value-driven prioritization of the business transactions associated with one or more customer accounts, based, for example, on customer relationship management documents, such as business transaction documents. The business transaction documents may include, for example, realized business transaction documents, or pipeline transaction documents, including, e.g., information pertaining to sales orders, service orders, opportunities, quotations, contracts and/or leads. For example, in performing a value-driven prioritization, the sales representative may be able to sort, filter, prioritize and/or categorize the business transactions based on any number of criteria from the business transaction documents that may correspond to one or more issues, the criteria including but not limited to, the account name, past and future contacts between the sales representative and the customer account, and sales data including total customer sales volume, realized sales orders, expected or potential sales, delivery dates, expiration dates and shipping delays. This may allow the sales representative to quickly and efficiently manage the business transactions and determine which customer accounts, and more specifically which business transactions associated therewith, the sales representative should address first and/or otherwise pay special attention.

A business transaction interface 102 may display information regarding, and organized with respect to, multiple customer accounts of a sales representative and/or business transactions for which the sales representative may be responsible. For example, the business transaction interface 102 may display business transaction information, including business data, for each of hundreds of customer accounts associated with a user 104. In an example embodiment, the business transaction interface 102 may include multiple views configured to allow a sales representative to define one or more issues by which to filter the business transactions, view the filtered business transactions and determine which of the issues to address.

The user 104 may represent, for example, a user of the business transaction interface 102. For example, the user 104 may include a sales representative who may use the business transaction interface 102 to view or manage his or her customer accounts, including the business transactions associated with each account. In other example embodiments the user 104 may include additional and/or different uses, including, for example, a manager who may use the interface 102 to view or manage the customer accounts, or business transactions thereof, of one or more associates whom the manager may be managing.

The business transaction interface 102 may be associated with, and/or provided by, a business transaction issue manager 106. The business transaction issue manager 106 may be configured to manage and provide business transactions including sales information and other information useful to the user 104, in a way that is easily accessible by, and useful to, the user 104. For example, the business transaction issue manager 106, perhaps in conjunction with other CRM components, may determine which business transactions are associated with an event or set of circumstances of importance or concern to the user 104.

The business transaction issue manager 106 may be part of a customer relationship management (CRM) system, which may include operational CRM 108. Operational CRM 108 may be used, for example, to automate various business processes, or to otherwise provide automated support of various aspects of customer relationship management. For example, operational CRM 108 may provide automated support for sales, marketing, and service for a business or businesses through sales process logic 110, marketing process logic 112, and service process logic 114, respectively.

In more specific examples, the sales process logic 110 may data mine and/or provide business transaction or sales information about one or more business transactions or issues. For example, sales process logic 110 may automate or provide information about predicting future sales, whom to contact in case of an issue, what actions to take to address an issue, provide administrative sales support, determine value information regarding a customer and/or business transaction, maintain customer-specific information, and/or otherwise data mine business data based on one or more defined issues. In the example embodiment of FIG. 1, the sales process logic 110 includes the business transaction issue manager 106, as shown, however, according to other example embodiments, the business transaction issue manager 106 may be included or otherwise associated with other portions of the system 100, including for example, service process logic 114.

Somewhat similarly, the marketing process logic 112 may automate and/or provide information about marketing. For example, the marketing process logic 112 may automate or provide information about current marketing trends, or may support implementation of a current marketing plan. For example, the marketing process logic 112 may conduct surveys, send e-mails or other communications to customers regarding a current marketing plan, or coordinate with marketing service providers to implement a marketing plan therewith.

The service process logic 114 may automate and/or provide information about services provided to customers as part of a sale or other interaction with the customers. For example, the service process logic 114 may automate and/or provide information about customer complaints or requests, or may provide technical or other support to customers, or may handle customer exchanges or refunds.

Thus, the operational CRM 108 provides support and assistance for identifying current or potential customers, executing sales to the customers, and then providing assistance to the customers in support of the executed sales. In other words, the operational CRM 108 facilitates present and future interactions between an enterprise (including the user 104) and its customers. Consequently, although not specifically or separately illustrated in FIG. 1, the operational CRM 108 may include, or be associated with, collaborative CRM, which may provide and manage a number of different communication techniques (e.g., e-mail, telephone, or other interactions) between the sales representative or other user 104 and a given customer(s). Thus, such collaborative CRM facilitates interactions, or collaborations, between various associated entities (e.g., between sales representatives and customers, between service providers and customers, and/or between marketing professionals/campaigns and customers)

As may be appreciated from the above description, the operational CRM 108 thus may be used to establish, maintain, and grow customers over a lifetime of the enterprise. In this regard, the operational CRM 108 may be assisted by other CRM features, e.g., analytics 116, ecommerce 118, and access modes 120.

The analytics 116, for example, may analyze data gathered by the operational CRM 108 (or by components thereof), or relevant data that is otherwise available, in order to improve or enhance customer relationships. For example, the analytics 116 may analyze data gathered by the sales process logic 110 and provide this information to the user 104 through the interface 102 (e.g., to identify new customers, increase profitability, or otherwise facilitate the job of the user 104). Similarly, the analytics 116 may analyze data associated with a marketing campaign of the marketing process logic 112. The analytics 116 also may provide support to the service process logic 114, e.g., by analyzing a success rate of a customer call center, or by tracking a number of returns of a sold product.

Ecommerce 118 may provide a way to manage a company's electronic commerce and/or internet interactions. For example, ecommerce 118 may manage the sales process logic 110 when customers purchase merchandise using a website of the enterprise, or using affiliate websites.

The access modes 120 may provide various views of a CRM processes depending on which user may be trying to access the system. For example, the access mode 120 may provide a first view of the interface 102 when the user 104 is a sales representative, and the access mode 120 may also provide a second view of the interface 102 when the user 104 is a sales manager.

The operational CRM 108, including the analytics 116, ecommerce 118, and the access modes 120 may all run off of a CRM server 122. The CRM server 122 may provide some or all of the customer relationship management (CRM) system referenced herein to other computing systems over a network. For example, the CRM server 122 may use CRM middleware 124 to provide CRM sales data from a data warehouse 126 to the operational CRM 108 for processing (e.g. by the sales processing logic 110 and/or the sales workbench system 106), and then to the device 128 for display on the interface 102.

The CRM middleware 124 may connect software components, devices and/or applications, including distributed applications and back-end or legacy applications. For example, the CRM middleware 124 may connect the CRM server 122 or operational CRM 108 to the data warehouse 126. The CRM middleware 124 may also for example, allow the interface 102 to interact with the data warehouse 126 through the operational CRM 108. The CRM middleware 124 may implement an appropriate messaging infrastructure, or other integration services or capabilities, as needed.

The data warehouse 126 may represent one or more of a database, memory or other storage device(s) containing information related to the CRM system. For example, the data warehouse 126 may contain customer account information, contact information, sales information, business transaction information and/or other business data that may be managed by the business transaction issue manager 106 and displayed in the business transaction interface 102 which may run on the device 128. In another example embodiment, the CRM information may be stored in multiple (types of) data warehouses 126, which may communicate with the CRM server 122.

The device 128 may be any device configured to display and/or interact with a CRM system. For example, the device 128 may be a personal digital assistant (PDA), mobile phone, laptop, desktop computer or other device capable of communicating with the CRM server 122 and allowing a user 104 to interact with the interface 102. In another example embodiment, multiple devices 128 may communicate with the CRM server 122.

The above description provides example implementations of a CRM system. It will be appreciated that many other features and functions may be included in such a CRM system than may be described here in detail. Further, the illustrated CRM system and system components may interact in any known or acceptable manner, e.g., using an underlying application platform. Thus, the various illustrated components may be combined, or may communicate with one another, in any acceptable or desired fashion. For example, the analytics 116, or component(s) thereof, may be considered to be part of (components of) the operational CRM 108, such as when the marketing process logic 112 includes analytics for analyzing a customer response to a previous marketing campaign.

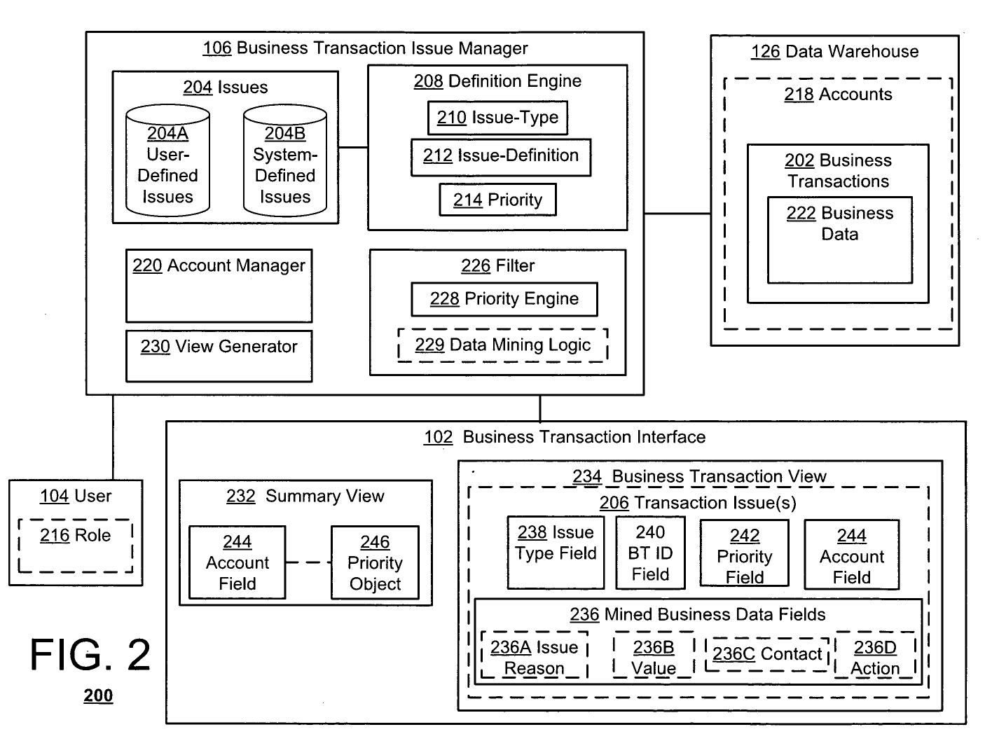

FIG. 2 is a block diagram of an example system 200 for a business transaction workbench system, according to an example embodiment. In the example of FIG. 2, the business transaction issue manager 106 may provide, from a plurality of business transactions 202 associated with the user 104, one or more of the business transactions 202 that are associated with and/or correspond to one or more issues 204. Then for example, the user 104 may determine which of the provided business transactions 202 to address, based at least in part on a relative importance of the detected issues 204.

The business transactions 202 may include, for example, transactions and/or interactions with one or more customers or clients. For example, during the course of a business relationship between a customer and a company, the company may interact with the customer on numerous occasions with regard to a wide range of issues. The interactions may be stored as the business transactions 202 and may include, for example, quotations, sales orders, new and/or existing opportunities, product return, shipping transactions, customer inquiries, human resource transactions, financing, sales appointments and contracts between the company and the customer. The business transactions 202 may include past, current and/or future (e.g., potential or scheduled) transactions between the company and the customer.

According to an example embodiment, the business transactions 202 may include internal processes to be completed by a company with regards to a customer. For example, the business transactions 202 may include a credit check to be performed prior to extending a customer financing or credit, engineering transactions regarding a product being developed, product packaging to be performed prior to shipping a product, or an account check to determine whether the customer has paid on an account balance. In other example embodiments, the business transactions 202 may include additional and/or different transactions.

An issue 204 may include an event and/or set of circumstances that may be of some importance and/or concern to the user 104. Example issues 204 may include contract end dates, delayed shipments, product returns, customer complaints, cancelled orders, expiring quotations, new opportunities and unpaid account balances. The issues 204 may be defined with regard to one or more of the business transactions 202. For example, one or more of the issues 204 may be defined with regard to sales appointments scheduled for within the next seven days. Then, for example, the business transaction issue manager 106 may parse and/or filter through the business transactions 202 associated with the user 104, and return the business transactions 202 for sales appointments scheduled for within the next seven days (or other desired time period).

The issues 204 may include user-defined issues 204A and/or system-defined issues 204B. A user-defined issue 204A may include an issue 204, as defined or otherwise provided by the user 104. The user-defined issues 204A may be defined by the user 104 based on the user's particular needs and what circumstances the user 104 determines to be important. The user-defined issues 204A may also be assigned or associated with a relative importance with regards to the user's 104 concerns. For example, the user 104 may include a sales associate who is concerned with expiring contracts for customers for whom the sales associate is responsible, wherein the sooner the contract expires, the more of a concern it may be to the sales associate. Then, for example, the user 104 may define a first user-defined issue 202 for contracts to expire within 3 days with the highest importance, a second user-defined issue 202 for contracts to expire within 7 days of medium importance, and a third user-defined issue 202 for contracts to expire in 8-30 days of low importance.

The system-defined issues 204B may be similar to the user-defined issues 204A, except rather than being defined by the user 104, the system-defined issues 204B may be defined by someone other than the user 104. The system-defined issues 204B may reflect a best-practice, or company or manager's policy on what the company or manager emphasizes as important. For example, a manager or system administrator may define one or more of the system-defined issues 204B for one or more associates whom the manager manages reflecting a company policy that associates are to follow-up with customers within 3 days after the shipment of a product to ensure proper delivery. Then, for example, the manager may define one or more of the system-defined issues 204B reflecting the company policy.

Based on a comparison of the business transactions 202 associated with the user 104 to the issues 204 (including one or more of the user-defined issues 204A and/or the system-defined issues 204B), the business transaction issue manager 106 may determine one or more transactions issues 206. A transaction issue 206 may include one or more of the business transactions 202 that correspond to one or more of the issues 204. For example, the business transactions 202 may include shipping transactions between a company and a customer. Then, for example, a user-defined issue 204A may be for delayed shipments wherein the value of the shipment is greater than $50,000. Then, for example, the transactions issue(s) 206 may include those business transactions 202 for delayed shipments with a value greater than $50,000.

A definition engine 208 may receive or otherwise determine one or more of the issues 204. For example, the definition engine 206 may allow the user 104 to define the user-defined issues 204A. According to an example embodiment, the definition engine 206 may allow the user 104 to select/deselect one or more of the issues 204 for which to search the business transactions 202. Then for example, the business transaction issue manager 106 may search for only the selected issues 204.

An issue 204 may include an issue-type 210, one or more issue-definitions 212 and one or more corresponding priorities 214. The issue-type 210 may include a category, class or other description of an issue 204. The issue-type 210 may be associated with one or more of the business transactions 203. For example, an issue-type 210 “contract ending soon” may be associated with business transactions 202 regarding contract end dates, a “shipment delayed” issue-type 210 may be associated with business transactions 202 regarding sales orders and shipping dates, and a “product bug detected” issue-type 210 may be associated with engineering business transactions 202.

The issue-definition 212 may include an algorithm, formula or other definition of an issue 204. The issue-definition 212 may include values associated with one or more of the business transactions 202. For example, the issue-definition 212 may include sales orders by customer ABC for 50 or more product units. Then for example, the business transaction issue manager 106 may compare the issue-definition 212 to the business transactions 202 to determine the transaction issue(s) 206.

According to an example embodiment, an issue 204 may include a single issue-type 210 and multiple issue-definitions 212. Each of the multiple issue-definitions 212 may correspond to a sub-class of the issue-type 210 that is of relative importance. For example, an issue-type 210 for shipping delays may have a first issue-definition 212 for shipping delays of 1-2 days, a second issue-definition 212 for shipping delays of 3-4 days and third issue-definition 212 for shipping delays for 5 or greater days. Then for example, each issue-definition 212 may be associated with a different priority 214.

The priority 214 may include a priority, importance or other value indicator associated with an issue 204, including the issue-type 210 and/or an issue-definition 212. For example, in continuing the shipping delay (e.g., issue-type 210) example with the three issue-definitions 212, the third issue-definition 212 for shipping delays of 5 or more days may have the highest priority 214, delays of 3-4 days may have medium priority 214 and the delays of 1-2 days may have the lowest priority. Then, for example, based on the priority 214, the user 104 may be able to more easily determine which transaction issues 206 to address first. For example, the highest priority 214 transaction issues 206, e.g., shipments of 5 or more days, may be addressed prior to lower priority 214 transaction issues 206, e.g., shipments with shipping delays of 4 days or fewer.

The definition engine 208, as shown in the example of FIG. 2, may include the issue-type 210, issue-definition 212 and priority 214, however it may be understood that in other example embodiments, the definition engine 208 may include one or more of the issue-type 210, issue-definition 212 and priority 214. Then, for example, an issue (e.g., 204A, 204B) may be defined based only on the issue-type 210, wherein the issue-type 210 may or may not include information generally associated with the issue-definition 212 and/or priority 214.

A role 216 may be associated with one or more of the business transactions 202. The role 216 may include a position, title and/or other identifier associated with the user 104. For example, the role 216 may identify the user 104 as a sales representative, a sales manager, an engineer, help desk personnel, or may more precisely identify the user 104. The role 216 may be associated with one or more of the business transactions 202, whereby the user 104 may be responsible for those business transactions 202 associated with the role 216. For example, a role 216 of sales representative may be associated sales orders and shipments business transactions 202, whereby a role 216 of engineer may be associated with engineering business transactions 202.

Then for example, based on the role 216, the definition engine 208 may limit the user 104 from defining or providing user-defined issues 204A that are inconsistent with the role 204. In another example embodiment, the definition engine 208 may only allow the user 104 to define or provide user-defined issues 204A consistent with the role 216. For example, if the user 104 is an engineer (e.g., role 216), then for example, the definition engine 208 may only allow the user 104 to define user-defined issues 204A associated with engineering business transactions 202, but not for example, associated with sales business transactions 202 (if sales business transactions 202 were not associated with the role 216 of engineer).

According to an example embodiment, the user 104 may be responsible for managing, or may otherwise be associated with, one or more accounts 218. The accounts 218 may include customer or client accounts. For example, the user 104 may be a sales representative responsible managing clients and/or customers corresponding to the accounts 218, or a portion thereof, including the business transactions 202 associated therewith. Each account 218 may be associated with one or more of the business transactions 202. For example, an account 218 for a customer ABC may be associated with a sales order placed by ABC, a credit check run with respect to ABC, a payment received from ABC, a product shipment to ABC and a product return by ABC. Then for example, a user 104 responsible for managing the account 218 for ABC may be responsible for at least a portion of the associated business transactions 202. According to another example embodiment, the user 104 may be responsible for, or otherwise associated with, one or more types of the business transactions 202, independent of the accounts 218. For example, an account executive (e.g., role 216) may be responsible for all of the business transactions 202 regarding receiving payments, providing invoices and/or providing refunds, independent of which of the accounts 218 the business transactions 202 are associated with.

An account manager 220 may determine which of the accounts 218 are associated with the user 104. The account manager 220 may, for example, parse through the accounts 218 to determine which of the accounts 218 the user 104 is responsible. Or for example, the account manager 220 may include a table or other listing associating the user 104 to one or more of the accounts 218. Then, for example, as referenced above, based on the accounts 218 for which the user 104 is responsible, the account manager 220 may determine for which of the business transactions 202 associated with the accounts 218 the user 104 may be responsible. For example, the account manager 220 may determine that the user 104 is only responsible for the shipping business transactions 202 for the account 218 of customer XYZ.

Each business transaction 202 may be associated with business data 222. The business data 222 may include data associated with one or more of the business transactions 202. For example, a sales order business transaction 202 may be associated with business data 222 including, the date when the order was placed, the product(s) ordered, the price per unit, the status of the order, the total price of the order, the status of payments for the order, the delivery date and who was the contact at the customer that authorized the order. According to another example embodiment, the business data 222 may be associated with the accounts 218 and include for example, such information as account size, length of relationship and credit information.

A filter 226 may parse through the business data 222 to determine which of the business transactions 202 associated with the user 104 correspond to or include one or more of the issues 204. The filter 226 may compare the values in one or more fields of the business data 222 to the issue-definitions 212 to determine the transaction issue(s) 206. For example, a system-defined issue 204B may include sales orders valued at $5000 or more with late delivery. Then for example, the filter 226 may parse the business data 222 associated with sales orders (e.g., business transactions 202) for customer ABC (e.g., from accounts 216), and return those business transactions 202 valued greater than $5000 as the transaction issue(s) 206. According to an example embodiment, the filter 226 may parse the business data 222 for those business transactions 202 associated with the user 104 as determined by the account manager 220.

A priority engine 228 may assign to each of the transaction issues 206 determined by the filter 226, the priority 214 that corresponds to the issue 204 associated with the transaction issue 206. For example, a user-defined issue 204A may include delayed product shipments where delays of 3 days or less are of priority 2 and delays greater than 3 days are of priority 1. Then for example, the filter 226 may parse the business transactions 202 and return three transaction issues 206 with shipments delays, the first two with delays of 2 days and the third one with a delay of 7 days. Then for example, the priority engine 228 may assign the first two transaction issues 206 a priority of 2 and the third transaction issue 206 a priority of 1.

Data mining logic 229 may determine or data mine, based on the business data 222, additional data or information to be provided. The data mining logic 229 may perform calculations, computations and/or other processing based on the issue-definition 212 and the business data 222 associated with each transaction issue 206. If, for example, an issue-definition 212 is for contracts to expire within 10 days, then the data mining logic 229 may determine how many remain until expiration of the contract based on a comparison of the business data 222 to the current calendar date. Or for example, if an issue-definition 212 is for account balances greater than $10,000 where no payment has been received, then data mining logic 229 may determine from the business data 222, for transactions issues 206, how much greater than $10,000 the account balances are and who to contact regarding requesting a payment.

A view generator 230 may provide information generated or otherwise determined by the business transaction issue manager 106 via an the business transaction interface 102. For example, the view generator 230 may generate a screen or view of the business transaction interface 102 including the transaction issues 206 and/or mined business data. The view generator 230 may, for example, generate a summary view 232 and/or a business transaction view 234, e.g., as part of the business transaction interface 102.

The summary view 232 may include, for example, a summary, overview or other abstraction of results determined by the business transaction issue manager 106. For example, the summary view 232 may include one or more of the accounts 218 in association with a summary of how many issues 104 were determined with regard to the business transactions 202 of each account, including their relative priorities (e.g., 214).

The business transaction view 234 may be similar to the summary view 232, except that the business transaction view 234 may include more detailed information in comparison to the summary view 232. The business transaction view 234 may include, for example, one or more transaction issues 206 associated with the user 104, as determined by the filter 226, the priority 214 associated with each transaction issue 206, the issue-type 210, the account 218 associated with the transaction issue 206 and one or more mined business data fields 236.

The mined business data fields 236 may include information associated with or otherwise derived from the business data 222 by the data mining logic 229. The mined business data fields 236 may include information not directly located within the fields of the business data 222, but may be extrapolated from or otherwise mined from the business data 222. Example mined business data fields 236 may include an issue reason field 236A, a value field 236B, a contact field 236C and an action field 236D.

The issue reason field 248A may include a basis, reason or other rationale as to what factor(s) associated with the transaction issue 206 corresponds to the issue-definition 212 of one or more of the issues 204. For example, the issue-definition 212 may include contracts to expire within 2 weeks, from customers located in the United States. Then for example, the issue reason field 248A may include the number of days until the contract is going to expire and the state in which the customer is located.

The value field 248B may include a value associated with the transaction issue 206. For example, the user 104 may have a metric or formula by which the accounts 218 and/or business transactions 202 are valued, which may be included in the value field 236B. Example values may include a monetary value associated with a contract, a number of units sold and/or an internal metric calculated by the data mining logic 229 and based on the length of relationship with a customer, the size of the customer and the credit of the customer. The value field 248B may include any other value data associated with the transaction issue 206 and/or account 218 that may be useful to the user 104.

The contact field 248C may include contact information associated with the accounts 218. For example, the business data 222 may include multiple contact personnel for an account 218 associated with the transaction issue 206. Then for example, based on the transaction issue 206, the data mining logic 229 may determine which contact personnel is appropriate and may include the contact information in the contact field 248C. The contact field 248C may include, for example, a name, title, phone number and/or e-mail address of a representative of an account 218 associated with the transaction issue 206.

The action field 236D may include one or more actions that may be taken to address the issue associated with the transaction issue 206. The action field 236D may include one or more actions dependent on the type of transaction issue 206 determined, the issue-type 210 and/or the issue-definition 212. For example, the data mining logic 229 may determine, based on an unpaid account balance (e.g., issue-type 210) that courses of action may include e-mailing a finance department, calling a customer and/or suspending an order until an account balance is paid.

In addition to including the mined business data fields 236, the business transaction view 234 may include an issue-type field 238, a business transaction identification (BT ID) field 240, a priority field 242 and an account field 244. The issue-type field 238 may include a description of the issue the transaction issue 206. For example, the issue-type field 238 may include at least a portion of the issue-type 210 of the issue associated with the transaction issue 206.

The BT ID field 240 may include an identification of the transaction issue 206. For example, each business transaction 202 may have a unique identification number or other identifier used to differentiate the business transactions 202 from one another. Then for example, the BT ID field 240 may include the identifier.

The priority field 242 may include the priority 214 of the issue 204 associated with the transaction issue 206. For example, the priority field 242 may include an alpha-numeric priority as determined based on the priority 214, such as “1”, “2”, “3”, “high”, “low”, “level 1”, “level 2”, etc. According to an example embodiment, the business transaction view 234 may include multiple transaction issues 206 which may be presented or ordered based on relative priorities, with the transaction issues associated with highest priority issues 204 appearing first. Or for example, the transaction issues 206 with the highest associated priority 214 may be presented with a visual indicator such as being bolded or underlined.

The account field 244 may include the account 218 associated with the transaction issue 206. For example, the transaction issue 206 may be associated with an account 218 for client 123, then, for example, the account field 244 may include the value “client 123.”

The summary view 232 may also include the account field 244 provided in association with a priority object 246. As referenced above, the summary view 232 may include a plurality of account fields 244, each account field including information from one or more of the accounts 218 associated with the user 104.

The priority object 246 may include a grouping, summary or other abstraction of the priorities (e.g., 214) of the issues 204 associated with the determined transaction issues 206. For example, the account field 244 may include account information for a customer ABC for which the user 104 is responsible. Then for example, the priority object 246 may include how many of the transaction issues 206 determined for the customer ABC are of high, medium and low priority. According to an example embodiment, the user 104 may then select an account 218 from the account field 244 and may be provided or otherwise directed to the business transaction view 234 including the transaction issues 206 associated with the selected account 218.

The business transaction issue manager 106 may be used by a user 104 to quickly and easily determine which of the business transactions 202 may be experiencing or soon to be experiencing a user-defined issue 204A and/or system-defined issue 204B. This may allow, for example, the user 104, who may be responsible for a large number of business transactions 202, to address those transaction issues 206 with the highest priority 214 first.

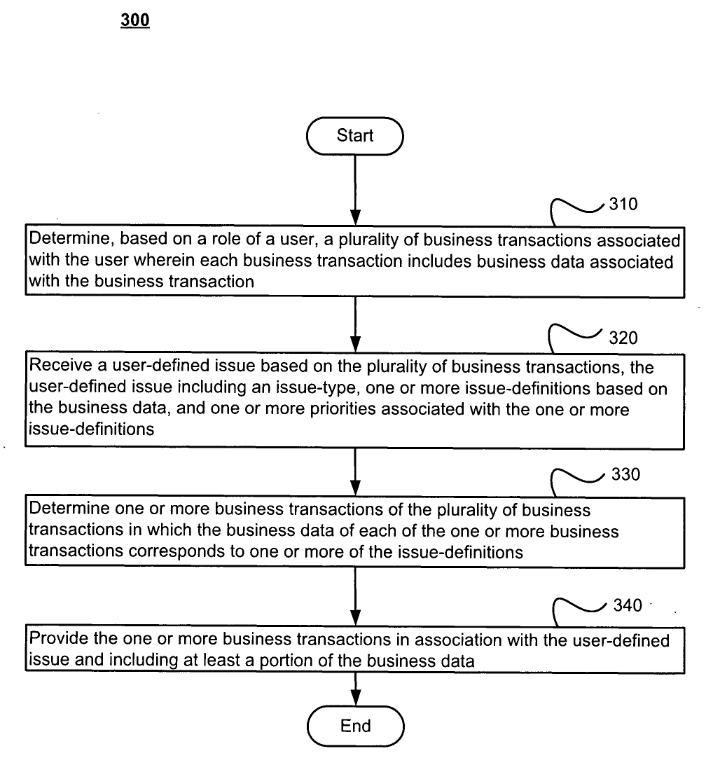

FIG. 3 is a flowchart 300 illustrating example operations of the system of FIG. 2. More specifically, FIG. 3 illustrates an operational flow 300 representing example operations related to customization result verification.

After a start operation, a plurality of business transactions associated with a user, wherein each business transaction includes business data associated with the business transaction, may be determined based on a role of the user (310). For example, as shown in FIG. 2, the account manager 218 may determine, based on the role 216 (and on a user request or other initiation), which of the accounts 218 are associated with the user 104. Then, for example, the account manager 220 may determine which of the business transactions 202 are associated with the user's accounts 218, the business transactions 202 including the business data 222.

A user-defined issue may be received, the user-defined issue being based on the plurality of business transactions and including an issue-type, one or more issue-definitions based on the business data, and one or more priorities associated with the one or more issue-definitions (320). For example, the definition engine 206 may receive the user-defined issues 204A from the user 104. For example, the user 104 may enter or provide the issue-type 210, issue-definition 212 and priority 214 for the user-defined issues 204A. The definition engine 206 may then check that the issue-type 210 corresponds to one or more issue-types 210 available to the user 104 based on the role 216.

One or more business transactions of the plurality of business transactions in which the business data of each of the one or more business transactions corresponds to one or more of the issue-definitions may be determined (330). For example, the filter 226 may determine, based on a comparison of the business data 222 to the issue-definitions 212 of the issues 204 (including the user-defined issues 204A and/or system-defined issues 204B), which of the business transactions 202 correspond one or more of the issues 204.

The one or more business transactions may be provided in association with the user-defined issue and including at least a portion of the business data (340). For example, the business transaction view 234 may include the transaction issue 206, including the issue-type field 238, the BT ID field 240 and the mined business data fields 236.

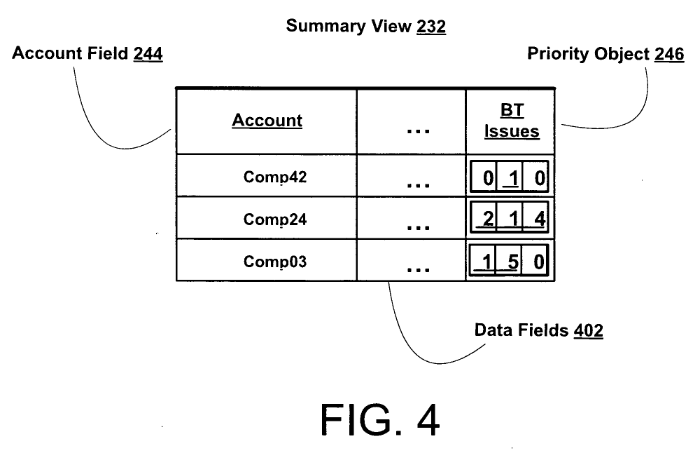

FIG. 4 is a block diagram of an example summary view 232, from FIG. 2, according to an example embodiment. The summary view 232 includes the account field 244 including the names of the accounts (e.g., 218) associated with a user (e.g., 104) provided in association with the priority object 246.

The priority object 246 may include the heading business transaction (BT) issues and in each field contain 3 columns, corresponding to three possible priorities for business transactions. In the example of FIG. 4, it may be determined that the account for Comp24 may have 7 business transactions that correspond to one or more issues. Of the 7 business transactions, 2 may be of the highest priority, 1 of medium priority and 4 of low priority. In other example embodiments, the number of columns may vary and may or may not correspond to each possible issue priority. For example, according to an example embodiment, the priority object 246 may only include a number of the highest priority issues for business transactions for a particular account. The summary view 232 may allow a user, for example, to determine that the two high priority issues of Comp24 should be addressed prior to the 1 medium priority issue of Comp42.

The summary view 232 may also include one or more data fields 402. The data fields 402 may include any additional and/or supplemental information not already included in the account field 244 and/or the priority object 246. For example, the data field 402 may include the total number of business transactions associated with each account, the location of the customer and/or a value metric associated with the customer, such as the size of the customer of the length of the relationship with the customer.

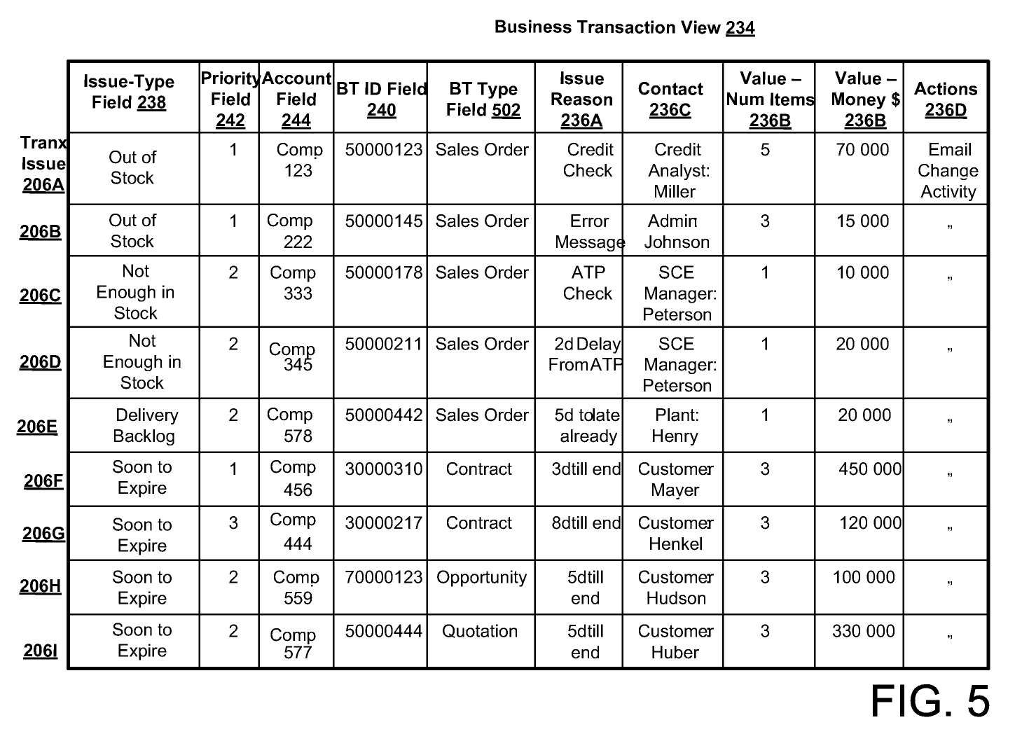

FIG. 5 is a block diagram of an example business transaction view 234, from FIG. 2, according to an example embodiment. The business transaction view 234 may include the issue-field 238 provided in association with the priority field 242, account field 244, BT ID field 240, issue reason field 236A, contact field 236C, value field 236B1, value field 236B2 and actions field 236D. Each row of the business transaction view 234 may correspond to a transaction issue 206A-I.

The business transaction view 234 may also include a business transaction type field 502. The business transaction type field 502 may include a description of the business transaction associated with the issue. For example, the five business transactions in the business transaction view 234 of FIG. 5 may be sales orders.

The transaction issue 206F with BT ID 30000310 may, for example, be associated with Comp456 and correspond to the soon to expire issue-type and have priority 1. The business transaction may be from a contract business transaction, that is to expire in 3 days. A user may then contact the customer Mayer to inquire further. The value of the contract may be 3 items, valued at $450,000 in total. The actions a user could take may include e-mailing, changing the status and reporting new activity.

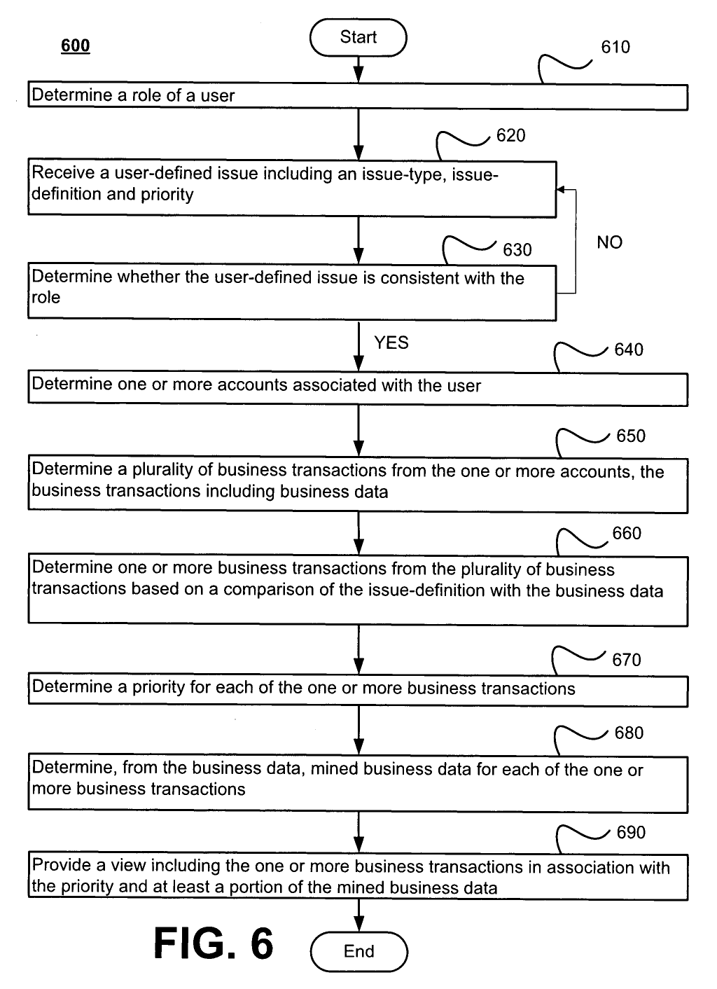

FIG. 6 is a flowchart 600 illustrating example operations of the system of FIG. 2. More specifically, FIG. 6 illustrates an operational flow 600 representing example operations related to customization result verification.

After a start operation, a role of a user may be determined (610). For example, as shown in FIG. 2, the account manager 220 may determine the role 216 of the user 104.

A user-defined issue may be received, the user-defined issue including an issue-type, issue-definition and priority (620). For example, the user 104 may define, via the definition engine 208, the user-defined issues 204A, including the issue-type 210, issue-definition 212 and priority 214.

It may be determined whether the user-defined issue is consistent with the role (630). For example, the definition engine 208 may determine whether the user-defined issues 204A are consistent with the role 216. If the definition engine 208 determines that a user-defined issue 204A is not consistent with the role 216, then the definition engine 208 may not save the user-defined issue 204A and/or notify the user 104 of the inconsistency such that the user 104 may redefine the user-defined issue 204A consistent with the role 216.

One or more accounts associated with the user may be determined (640). For example, the account manager 220 may determine which of the accounts 218 are associated with the user 104.

A plurality of business transactions from the one or more accounts may be determined, the business transactions including business data (650). For example, the account manager 220 may determine which of the business transactions 202, including the business data 222, are associated with user accounts (e.g., 218).

One or more business transactions from the plurality of business transactions may be determined based on a comparison of the issue-definition with the business data (660). For example, the filter 226 may determine one or more transaction issues 206, e.g., which of the business transactions 202 correspond with the issues 204 based on a comparison of the business data 222 with the issue-definition 212 of each issue 204.

A priority may be determined for each of the one or more business transactions (670). For example, the priority engine 228 may associate the priority 214 with the business transactions 202 consistent with the issue-definitions 212.

Mined business data may be determined from the business data for each of the one or more business transactions (680). For example, the data mining logic 229 may determine the data to be included in the mined business data fields 256, including the issue reason field 236A, the value field 236B, the contact field 236C and the action field 236D.

A view including the one or more business transactions may be provided in association with the priority and at least a portion of the mined business data (690). For example, the view generator 230 may generate the business transaction view 234, including the transaction issue 206 and the mined business data fields 236.

Although the above description is provided in terms of specific examples, it will be appreciated that many other examples and settings are contemplated. For example, the term business document should be interpreted broadly as including any document that is used in profit generation of some sort, although the business document 104 also may refer to documents for non-profit endeavors as well, including, for example, schools, churches, charities, hospitals, or virtually any other organization. Further, the business document 104 is merely an example, and other applications, such as applications for personal use, also may be used.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A system comprising:
a definition engine configured to receive one or more user-defined issues based on a role associated with a user, the one or more user-defined issues including an issue-type, one or more issue-definitions and one or more priorities corresponding to the one or more issue-definitions;
an account manager configured to determine one or more accounts associated with the user, each account including business data associated with at least one of a plurality business transactions;
a filter configured to determine at least a one or more of the plurality of business transactions associated with the one or more user-defined issues based on a comparison of the business data with the one or more issue-definitions;
a priority engine configured to determine which of the one or more priorities correspond to each of the one or more business transactions, based on the comparison; and
a view generator configured to generate one or more views including at least a grouping of the one or more business transactions in association with at least a portion of the business data and the one or more user-defined issues.

2. The system of claim 1 wherein the definition engine is configured to determine one or more system-defined issues associated with the role.

3. The system of claim 1 wherein the definition engine is configured to allow the user to define the one or more user-defined issues wherein the issue-type of the one or more user-defined issues corresponds to one or more issue-types associated with the role.

4. The system of claim 1 wherein the filter is configured to parse the business data of each of the plurality of business transactions associated with the user for at least a portion of the business data corresponding to one or more of the issue-definitions.

5. The system of claim 1 wherein the priority engine is configured to assign a priority of the one or more priorities to each of the one or more business transactions.

6. The system of claim 1 wherein the view generator is configured to provide a summary view including the one or more accounts in association with a summary of the priorities associated with the one or more business transactions associated with each of the one or more accounts.

7. The system of claim 1 wherein the view generator is configured to provide a business transaction view including one or more groupings of the business data, grouped based on each business transaction.

8. The system of claim 1 wherein the filter includes data mining logic configured to determine an issue reason associated with each of the one or more business transactions based on the comparison.

9. The system of claim 1 wherein the filter includes data mining logic configured to determine a contact associated with each of the one or more business transactions based on the business data associated with each business transaction.

10. A computer program product for handling a plurality of business transactions, associated with a user, including business data consistent with a user-defined issue defined by the user, the computer program product being tangibly embodied on a computer-readable medium and including executable code that, when executed, is configured to cause a data processing apparatus to provide a business transaction interface comprising:
a grouped plurality of fields that are grouped with respect to each of the plurality of business transactions including:
an issue-type field configured to identify the user-defined issue;
a business transaction identification field configured to identify each of the plurality of business transactions;
an issue-reason field configured to provide results of a comparison of the business data of each of the plurality of business transactions with an issue-definition of the user-defined issue; and
a priority field configured to provide a priority associated with each business transaction of the plurality of business transactions based on the issue-reason field wherein the issue-definition corresponds to the priority.

11. The computer program product of claim 10 wherein the interface comprising the grouped plurality of fields includes a value field configured to provide a determination of a value of each of the plurality of business transactions as associated with the user-defined issue.

12. The computer program product of claim 11 wherein the value field comprises a monetary value.

13. The computer program product of claim 10 wherein the interface comprising the grouped plurality of fields includes an issue contact field configured to provide, from the business data, an identification of a contact associated with each of the plurality of business transactions and the user-defined issue.

14. The computer program product of claim 10 wherein the interface comprising the grouped plurality of fields includes an action field providing one or more actions to be performed with respect to each of the plurality of business transactions.

15. The computer program product of claim 10 wherein the interface comprising the grouped plurality of fields includes an account field configured to identify an account associated with the user including each of the plurality of business transactions.

16. A method comprising:
determining, based on a role of a user, a plurality of business transactions associated with the user wherein each business transaction includes business data associated with the business transaction;
receiving a user-defined issue based on the plurality of business transactions, the user-defined issue including at least one of an issue-type, one or more issue-definitions based on the business data, and one or more priorities associated with the one or more issue-definitions;
determining one or more business transactions of the plurality of business transactions in which the business data of each of the one or more business transactions corresponds to one or more of the issue-definitions; and
providing the one or more business transactions in association with the user-defined issue and including at least a portion of the business data.

17. The method of claim 16 wherein the determining, based on a role of a user, a plurality of business transactions comprises determining one or more customer accounts associated with the user, the one or more customer accounts comprising the plurality of business transactions.

18. The method of claim 16 wherein the determining, based on a role of a user, a plurality of business transactions comprises determining that the issue-type corresponds to the role of the user.

19. The method of claim 16 wherein the receiving comprises receiving the user-defined issue wherein the issue-type corresponds to the plurality of business transactions.

20. The method of claim 16 wherein the determining one or more business transactions comprises determining a priority, from the one or more priorities, associated with each of the one or more business transactions.
